(19) United States
(12) Patent Application Publication
(10) Pub. No.: US 2012/0308949 A1
(43) Pub. Date: Dec. 6, 2012

(54) SLIDING DEVICE AND SLIDING SYSTEM USING THE SAME

(75) Inventors: Masaaki HIROSE, Aichi-gun (JP); Yoshinobu Suzuki, Nagakute-city (JP); Koshi Adachi, Sendai-city (JP)

(73) Assignees: TOHOKU UNIVERSITY, Sendai-shi (JP); DENSO CORPORATION, Kariya-city (JP)

(21) Appl. No.: 13/482,209

(22) Filed: May 29, 2012

(30) Foreign Application Priority Data
May 30, 2011 (JP) 2011-120506

(51) Int. Cl. F27D 19/00; B32B 9/04

(52) U.S. Cl. 432/52; 428/408

(57) ABSTRACT

In a sliding device, a first base member and a second base member are slid relative to each other. A hard carbon film is disposed on at least one of a first surface of the first base member and a second surface of the second base member opposed to the first surface of the first base member. Further, an intermediate layer is disposed between the hard carbon film and the one of the first surface of the first base member and the second surface of the second base member. The intermediate layer is made of a compound containing silicon and oxygen.

### CROSS REFERENCE TO RELATED APPLICATION

This application is based on Japanese Patent Application No. 2011-120506 filed on May 30, 2011, the disclosure of which is incorporated herein by reference.

### TECHNICAL FIELD

The present disclosure relates to a sliding device that realizes a favorable low friction state in the atmosphere and a sliding system using the sliding device.

### BACKGROUND

A sliding device is for example described in a patent document 1, which is referred later. In the described sliding device, a carbon nitride film is formed on a surface of at least one of two sliding members, which are opposed to each other and slid relative to each other. A sliding part where the surfaces of the sliding members are slid relative to each other is disposed in a gaseous nitrogen atmosphere.

In the described sliding device, since the sliding part is in the gaseous nitrogen atmosphere, oxidization of the carbon nitride film is restricted and a low friction state where a coefficient of friction is equal to or lower than 0.01 is realized.

A non-patent document 1, which is referred later, describes to achieve a low friction state even in the atmosphere by continuously heating a sliding part of sliding members at a predetermined temperature according to an ambient humidity. One of the sliding members has a carbon nitride film on its surface.

The non-patent document 1 also describes heating temperatures that realize a low friction state where the coefficient of friction is equal to or less than 0.05. In the atmosphere where the relative humidity is in a range between 60% and 70%, the heating temperature is approximately 125 degrees Celsius (° C.) or higher. In the atmosphere where the relative humidity is in a range between 20% and 50%, the heating temperature is approximately 100° C. or higher. In the atmosphere where the relative humidity is 5% or less, the heating temperature is 75° C. or higher.
<Patent Document 1>
JP2002-339056A
<Non-Patent Document 1>
Yuya YOSHIKAWA, Takayuki TOKOROYAMA, and Noritsugu UMEHARA, “Control of Friction and Wear Properties of CNₓ Coatings with Rising Temperature in Ambient Air”, Transactions of the Japan Society of Mechanical Engineers (C), Vol. 74, No. 747 (2008-11), pp. 173-178

In the sliding device of the patent document 1, a nitrogen container for forming the gaseous nitrogen atmosphere, and a nozzle for injecting nitrogen are necessary.

Although the non-patent document 1 teaches that the low friction state in the atmosphere is realized, the coefficient of friction is at a level of 0.05 or less. Namely, realization of a lower friction state where the coefficient of friction is 0.01 or less is not achieved.

### SUMMARY

It is an object of the present disclosure to provide a sliding device that is capable of realizing a low friction state where a coefficient of friction is 0.01 or less even in the atmosphere. It is another object of the present disclosure to provide a sliding system using the sliding device.

According to a first aspect of the present disclosure, a sliding device includes a first base member having a first surface and a second base member having a second surface. The second surface is opposed to the first surface, and the first base member and the second base member are slid relative to each other. In the sliding device, a hard carbon film is disposed on at least one of the first surface of the first base member and the second surface of the second base member, and an intermediate layer is disposed between the hard carbon film and the one of the first surface of the first base member and the second surface of the second base member. The intermediate layer is made of a compound containing silicon and oxygen.

In the above sliding device, a low friction state where a coefficient of friction is equal to or less than 0.01 is realized even in the atmosphere.

According to a second aspect of the present disclosure, a sliding system includes the sliding device according to the first aspect, a heating device for heating the sliding device, and a control device. The control device controls the heating device to perform a temperature change operation in which a heating temperature of the sliding device by the heating device is increased to a predetermined temperature and decreased from the predetermined temperature and to keep the heating temperature in a predetermined temperature range after the temperature change operation.

In the above sliding system, the heating temperature of the sliding device is changed and then kept in the predetermined temperature range by the heating device and the control device. Therefore, the low friction state is stably maintained in the sliding device.

According to a third aspect of the present disclosure, a sliding system includes the sliding device according to the first aspect, and a temperature control part. The sliding device is disposed adjacent to a heat source to be heated by the heat source. The temperature control part controls the heat source to perform a temperature change operation in which a heating temperature of the sliding device is increased to a predetermined temperature and decreased from the predetermined temperature and to keep the heating temperature in a predetermined temperature range after the temperature change operation.

In the above sliding system, the heating temperature of the sliding device is changed and then kept in the predetermined temperature range using the heat of the heat source by the temperature control part. Therefore, the low friction state is stably maintained in the sliding device.

According to a fourth aspect of the present disclosure, a sliding system includes a sliding device, a heating device for heating the sliding device and a control device. The sliding device includes a first base member, a second base member, and a hard carbon film. The first base member has a first surface, and the second base member has a second surface opposed to the first surface. The first base member and the second base member slide relative to each other. The hard carbon film is disposed on at least one of the first surface of the first base member and the second surface of the second base member. The control device controls the heating device to perform a temperature change operation in which a heating temperature of the sliding device by the heating member is increased to a predetermined temperature and decreased from the predetermined temperature and to keep the heating temperature in a predetermined temperature range after the temperature change operation.

In the above sliding system, the low friction state is achieved by the hard carbon film. Further, the sliding device is heated in the predetermined temperature range after the temperature is changed. Therefore, the low friction state is stably maintained in the sliding device.

According to a fifth aspect of the present disclosure, a sliding system includes a sliding device and a temperature control part. The sliding device is disposed adjacent to a heat source. The sliding device includes a first base member, a second base member, and a hard carbon film. The first base member has a first surface, and the second base member has a second surface opposed to the first surface. The first base member and the second base member slide relative to each other. The hard carbon film is disposed on at least one of the first surface of the first base member and the second surface of the second base member. The temperature control part controls the heat source to perform a temperature change operation in which a heating temperature of the sliding device is increased to a predetermined temperature and decreased from the predetermined temperature and to keep the heating temperature in a predetermined temperature range after the temperature change operation.

In the above sliding system, the heating temperature of the sliding device is changed and then kept in the predetermined temperature range using the heat of the heat source by the temperature control part. Therefore, the low friction state is stably maintained in the sliding device.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is an enlarged cross-sectional view of a base member of a sliding device with a two-layer coating according to a first embodiment;

FIG. 2 is a schematic diagram for illustrating a method of forming the sliding device according to the first embodiment;

FIG. 3 is a graph illustrating a coefficient of friction of the sliding device according to the first embodiment;

FIG. 4 is a graph illustrating Raman scattering intensity of an amorphous carbon film according to the first embodiment;

FIG. 5 is a graph illustrating a coefficient of friction with respect to a Raman ratio I_{G}/I_{D} according to the first embodiment;

FIG. 6 is a graph illustrating absorption intensity of an intermediate layer according to the first embodiment;

FIG. 7 is a chart illustrating thickness levels of the amorphous carbon film and the intermediate layer according to the first embodiment;

FIG. 8 is a schematic diagram for illustrating a method of measuring a coefficient of friction of the sliding device according to the first embodiment;

FIG. 9 is a graph illustrating a coefficient of friction of an amorphous carbon film having a thickness of 100 nm according to the first embodiment;

FIG. 10 is a graph illustrating a coefficient of friction of an amorphous carbon film having a thickness of 1000 nm as a comparative example according to the first embodiment;

FIG. 11 is a schematic diagram of a sliding system according to a second embodiment;

FIG. 12 is a graph illustrating a coefficient of friction of a sliding device of the sliding system, when a heating temperature is changed, according to the second embodiment;

FIG. 13 is a graph illustrating a temperature range where the coefficient of friction is 0.01 or less according to the second embodiment;

FIG. 14 is a schematic diagram of an engine system according to a third embodiment;

FIG. 15 is a schematic diagram of an injector of the engine system according to the third embodiment;

FIG. 16 is a schematic diagram of an engine system according to a fourth embodiment; and

FIG. 17 is a schematic diagram of an EGR valve of the engine system according the fourth embodiment.

### DETAILED DESCRIPTION

Hereinafter, exemplary embodiments of the present disclosure will be described with reference to the accompanying drawings. In subsequent exemplary embodiments, parts similar to those of a preceding embodiment will be designated with like reference numbers, and descriptions thereof will not be repeated.

### First Embodiment

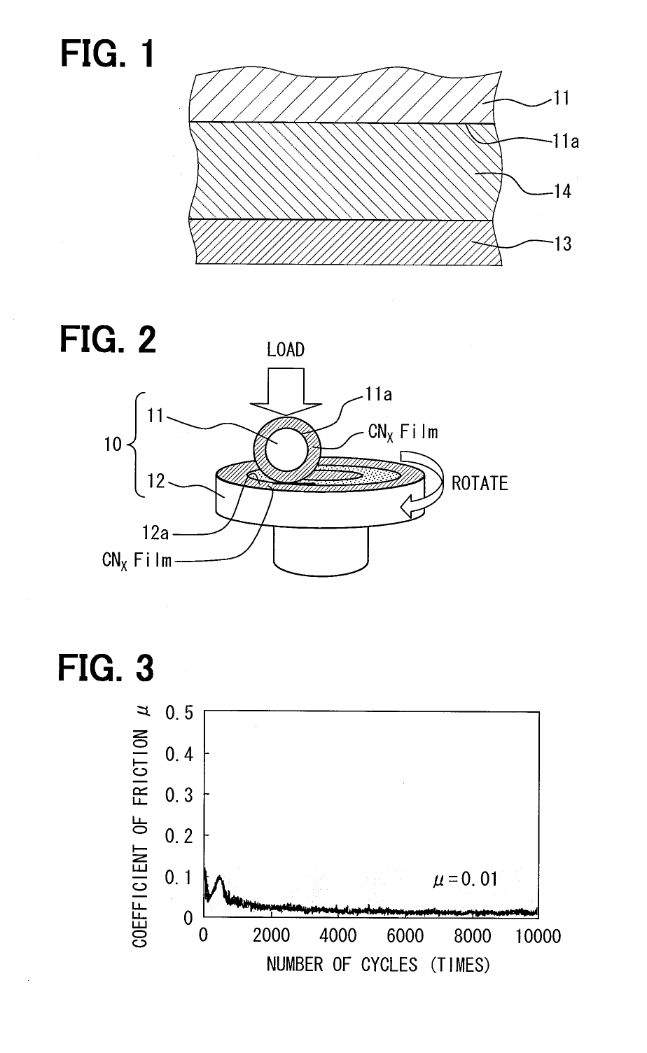

A sliding device 10 according to the first embodiment will be described with reference to FIGS. 1 through 6.

The sliding device 10 includes a pair of base members (e.g., first base member and second base member) 11, 12, as shown in FIG. 2. The base members 11, 12 slide relative to each other in a manner that a surface (e.g., first surface) 11a of the base member 11 and a surface (e.g., second surface) 12a of the base member 12 are opposed to each other. A hard carbon film 13 is formed on at least one of the surface 11a of the base member 11 and the surface 12a of the base member 12, as shown in FIG. 1. An intermediate layer 14 is formed between the surface 11a, 12a and the hard carbon film 13.

The hard carbon film 13 has a thickness of at least 1 nanometer (nm) and at most 500 nm. In the present embodiment, the thickness of the hard carbon film 13 is approximately in a range from 20 nm to 30 nm. The intermediate layer 14 has a thickness of at least 1 nm and at most 1000 nm. In the present embodiment, the thickness of the intermediate layer 14 is approximately in a range from 50 nm to 60 nm.

The above sliding device 10 is formed in a manner shown in FIG. 2. As the base member 11, a ball that is for example made of silicon nitride (Si₃N₄) is prepared. As the base member 12, a disc that is for example made of silicon nitride (Si₃N₄) and has a circular plate shape is prepared. A carbon nitride (CNₓ) film is formed on each of the surface 11a of the base member 11 and the surface 12a of the base member, as an abrasion-resistant film having a high degree of hardness.

The base member 11 is fixed to a gauge head (not shown), and is disposed on an upper side of the base member 12 (e.g., on the surface 12a). The base member 11 is held in a non-rotatable state as being fixed to the gauge head. Further, a predetermined load (e.g., 400 mN) is applied to the top of the base member 11.

The base member 12 is rotated at a predetermined speed (e.g., 250 rpm) by an external motor while the base member 11 is held in the non-rotatable state. Thus, the base member 11 and the base member 12 are slid relative to each other. At this time, the base member 11 and the base member 12 are slid in an ambient of 100% inert gas such as argon gas, nitrogen gas, or helium gas (i.e., 0% air or oxygen).

When the base member 11 and the base member 12 are slid relative to each other under the above described condition, a two-layer coating including the hard carbon film 13 and the intermediate film 14 as described in association with FIG. 1 is formed on at least one of the surface 11a of the base member 11 and the surface 12a of the base member 12. In this way, the sliding device 10 is produced.

FIG. 3 is a graph illustrating a coefficient of friction μ(coefficient of kinetic friction) between sliding surfaces of the base members 11, 12 with respect to the number of cycles, when one rotation of the base member 12 is defined as one cycle. As shown in FIG. 3, since the sliding device 10 has the two-layer coating, a low friction state is maintained.

Namely, although the coefficient of friction μ is approximately 0.1 in an initial state, the coefficient of friction gradually reduces after the initial state. After approximately 2000 cycles, a low friction state where the coefficient of friction is 0.01 (μ=0.01) is maintained.

In the two-layer coating, the hard carbon film 13 is formed as an amorphous carbon film (amorphous C) 13 that exhibits short-range order in regard to the arrangement of atoms. The amorphous carbon film 13 is made from carbon contained in the carbon nitride film (CNₓ) formed on the surfaces 11a, 12a of the base members 11, 12 in an initial stage. In a Raman spectrum, the amorphous carbon film 13 satisfies a relation of I_{G}/I_{D}≧1, in which I_{G} is a Raman scattering intensity of a G-band caused by graphite and I_{D} is a Raman scattering intensity of a D-band caused by diamond. For example, the G-band is observed at a wavenumber of approximately 1580 cm⁻¹ and the D-band is observed at a wavenumber of approximately 1350 cm⁻¹.

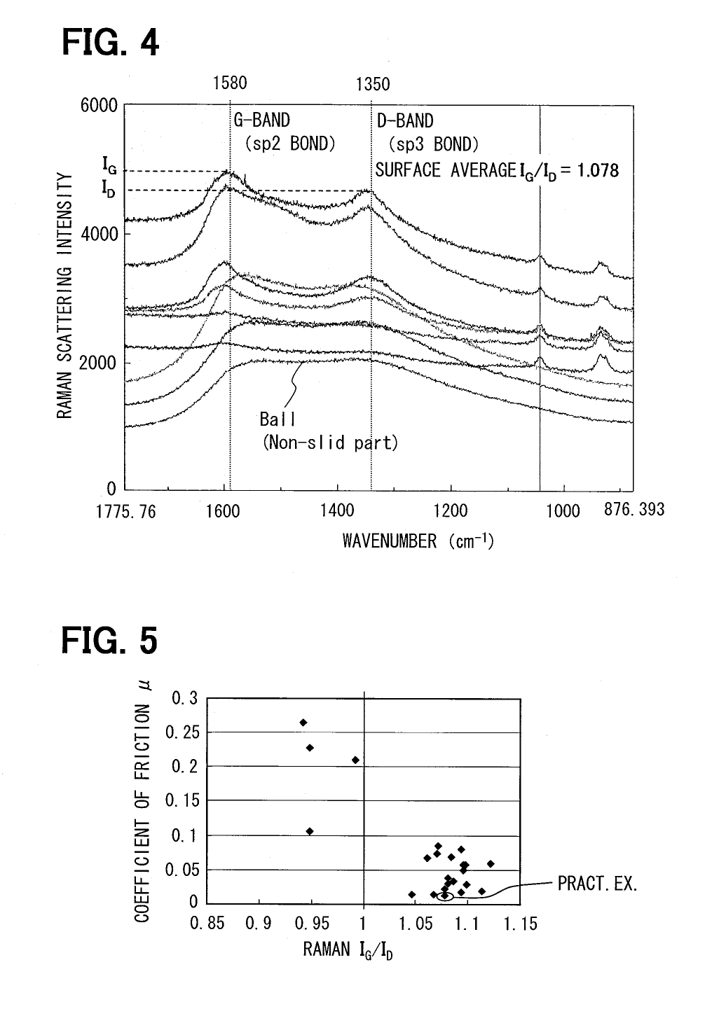

FIG. 4 is a graph illustrating a result of a Raman spectrum analysis in which the Raman scattering intensity is measured at multiple positions (e.g., eight positions) in a sliding part between the base member 11 and the base member 12.

An average of the ratios I_{G}/I_{D} of the multiple positions is 1.078. The value of the ratio I_{G}/I_{D} being equal to or greater than one means that a large number of graphite structures (I_{G}) are formed in the amorphous carbon film 13.

As shown in FIG. 5, the sliding device 10 of the present embodiment realizes the relation of I_{G}/I_{D}≧1 (e.g., I_{G}/I_{D}=1.078) and the coefficient of friction μ being equal to 0.01. The other plots in FIG. 5 indicate results when the ambient gas condition in forming the sliding device 10 is modified to an ambient gas condition of the inert gas and oxygen (e.g., oxygen density is 1 to 100%). Of the other plots, the plots having the coefficient of friction μ greater than 0.01 and the ratio I_{G}/I_{D} being equal to or greater than one indicate the results where only the amorphous carbon film 13 is formed but the intermediate layer 14 is not formed.

In the two-layer coating, the intermediate layer 14 is formed as an amorphous silicon oxide (amorphous SiO) film 14 that exhibits short-range order in regard to the arrangement of atoms, similar to the hard carbon film 13. The amorphous silicon oxide film 14 is formed of a compound containing silicon and oxygen. The amorphous silicon oxide film 14 is formed because oxygen is bonded with silicon of the silicon nitride (Si₃N₄) of the base members 11, 12.

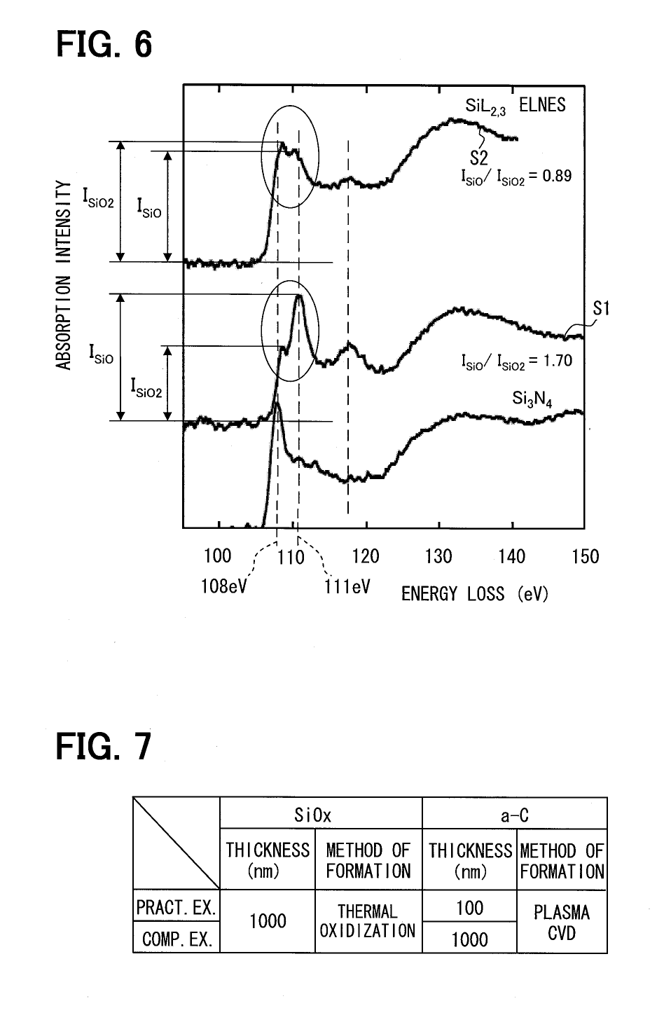

FIG. 6 is a graph illustrating a result of an energy-loss near-edge structure (ELNES) analysis of silicon of the amorphous silicon oxide film 14. An ELNES spectrum of FIG. 6 is, for example, measured by EELS Spectrometer, ENFINA™ 1000 of Gatan Inc.

As shown in FIG. 6, in the ELNES spectrum of silicon, the amorphous silicon oxide film 14 satisfies a relation of I_{SiO}/I_{SiO2}≧1, in which I_{SiO2} is an absorption intensity caused by silicon dioxide (SiO₂) and I_{SiO} is an absorption intensity caused by silicon oxide (SiO). For example, the absorption intensity of the silicon dioxide is observed at energy loss of approximately 108 eV, and the absorption intensity of the silicon oxide is observed at energy loss of approximately 111 eV.

In FIG. 6, a spectrum S1 corresponds to the sliding device 10 of the present embodiment. A spectrum S2 corresponds to a sliding device of a comparative example where the ambient gas condition in forming the sliding device is atmosphere and in which only the silicon oxide film of the two-layer coating is formed. In the comparative example, the coefficient of friction μ is equal to 0.2. According to the spectrum S1, the sliding device 10 of the present embodiment satisfies the relation of I_{SiO}/I_{SiO2}≧1 (e.g., I_{SiO}/I_{SiO2}=1.70) and the coefficient of friction μ being equal to 0.01.

In the present embodiment, as shown in FIGS. 3 and 5, the low friction state where the coefficient of friction μ is equal to or less than 0.01 can be realized even in the atmosphere.

In the sliding device 10 of the present embodiment, the coefficient of friction μ being equal to 0.01 is achieved with regard to the amorphous carbon film (hard carbon film) 13 having the thickness of 20 nm to 30 nm. Hereinafter, a consideration result about the thickness of the amorphous carbon film 13 will be described.

As test samples, a practical example and a comparative example are prepared, as shown in FIG. 7. The amorphous silicon oxide film 14 of the practical example is formed by a thermal oxidization technique and has a thickness of 1000 nm. Likewise, the amorphous silicon oxide film 14 of the comparative example is formed by the thermal oxidization technique, and has a thickness of 1000 nm.

The amorphous carbon film 13 of the practical example is formed by a plasma chemical vapor deposition (CVD) technique, and has a thickness of 100 nm. The amorphous carbon film 13 of the comparative example is formed by the plasma CVD technique, and has a thickness of 1000 nm.

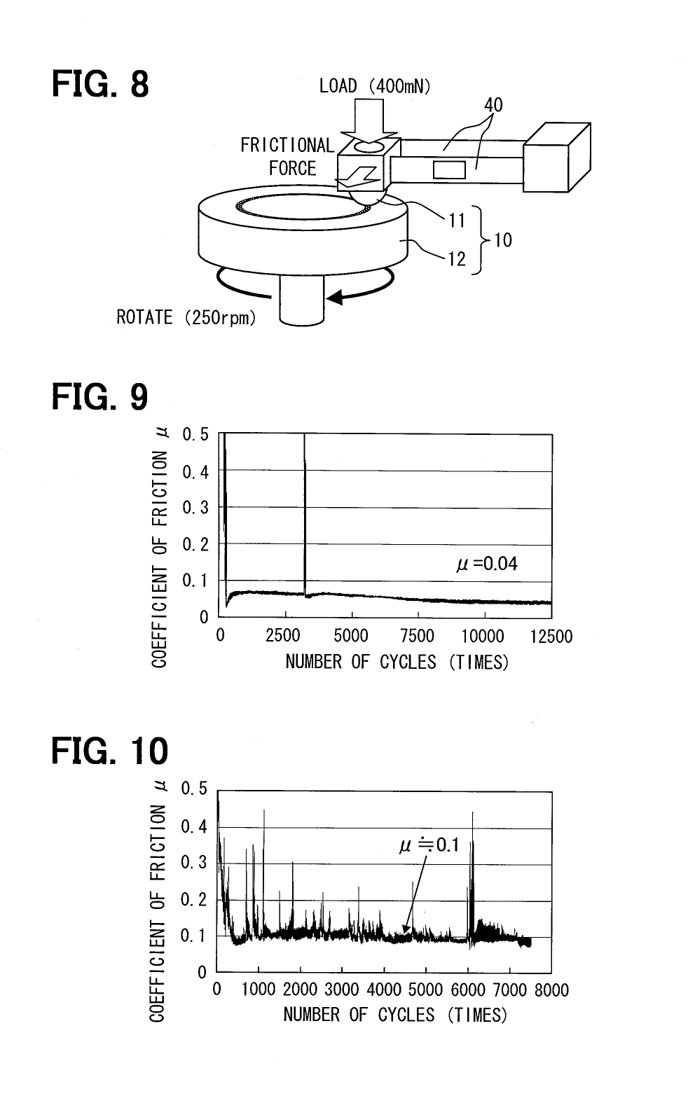

As shown in FIG. 8, the coefficient of friction μ per one cycle (rotation number) is measured through a gauge head 40 by rotating the base member 12 at a speed of 250 rpm in a condition where a load of 400 mN is applied to the base member 11 in the ambient of nitrogen (N₂).

As a result, as shown in FIG. 9, the practical example in which the thickness of the amorphous carbon film 13 is 100 nm achieves the coefficient of friction μ of 0.04. As shown in FIG. 10, the comparative example in which the thickness of the amorphous carbon film 13 is 1000 nm achieves the coefficient of friction μ of 0.1. It is to be noted that the above described first embodiment in which the thickness of the amorphous carbon film 13 is in the range from 20 nm to 30 nm achieves the coefficient of friction μ of 0.01. Here, the practical example does not necessarily means a best example, but means one of examples to be put into practice.

Accordingly, it is appreciated that the coefficient of friction μ increases with an increase in the thickness of the amorphous carbon film 13, and the low friction state is achieved by reducing the thickness of the amorphous carbon film 13 smaller than a predetermined thickness.

### Second Embodiment

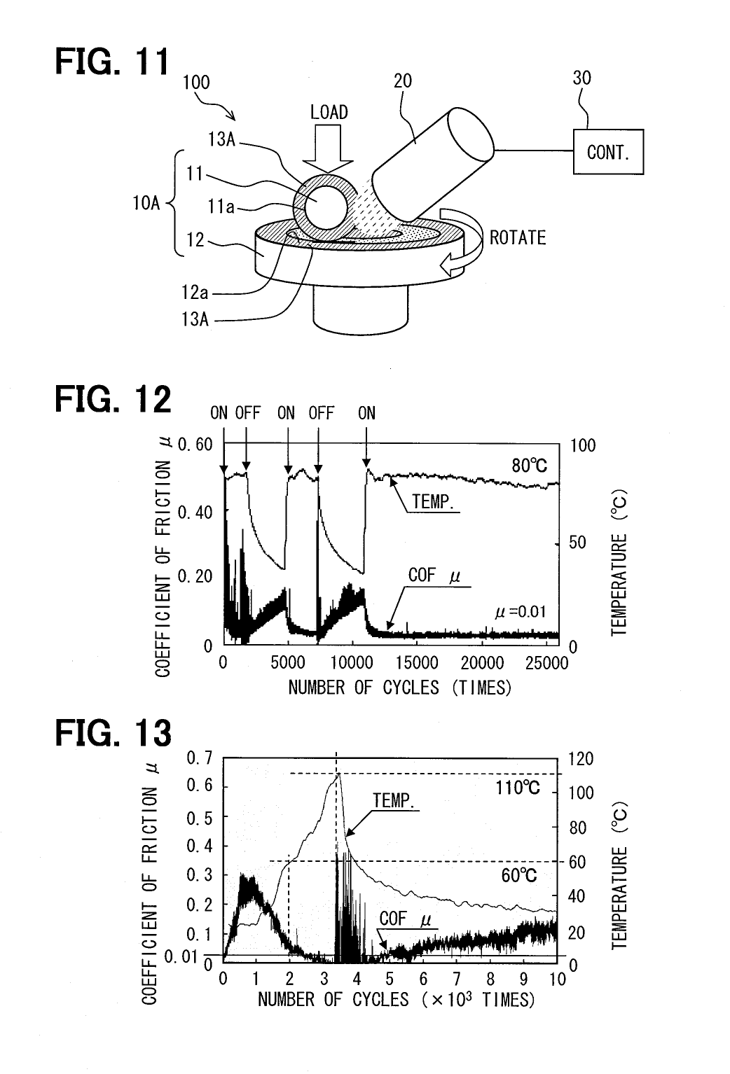

A sliding system 100 according to the second embodiment is shown in FIG. 11. The sliding system 100 includes a sliding device 10A, a heater 20, and a controller 30.

The sliding device 10A includes a pair of base members (first base member and second base member) 11, 12. The surfaces 11a, 12a of the base members 11, 12 are opposed to each other. The base members 11, 12 are slid relative to each other.

The base member 11 is a ball that is made of silicon oxide (Si₃N₄), and the base member 12 is a disc that is made of the silicon oxide (Si₃N₄) and has a circular plate shape. A hard carbon film 13A is formed on each of the surface 11a of the base member 11 and the surface 12a of the base member 12. The hard carbon film 13A is a carbon nitride (CNₓ) film as the abrasion-resistant film having a high degree of hardness.

The base member 11 is fixed to a gauge head (not shown), and is disposed on the upper side of the base member 12 (e.g., on the surface 12a). The base member 11 is held in a non-rotatable state as being fixed to the gauge head. A predetermined load (e.g., 400 mN) is applied to the top of the base member 11. The base member 12 is rotated at a predetermined rotation speed (e.g., 250 rpm) by an external motor. When the base member 12 is rotated by the external motor, the base member 11 and the base member 12 are slid relative to each other in the condition where the base member 11 is held in the non-rotatable state. One rotation of the base member 12 corresponds to one cycle of the sliding.

The heater 20 is an example of a heating device for heating the sliding device 10A. The heater 20 is disposed externally and adjacent to the sliding device 10A to intensively heat a sliding part between the base member 11 and the base member 12.

The heater 20 is, for example, an electric heater. The heater 20 heats the sliding device 10A when an electric power supply to the heater 20 is turned on. The heater 20 is not limited to a heater disposed external to the sliding device 10A. As another example, the heater 20 may be embedded within the base member 11 or the base member 12.

The controller 30 is an example of a control device that controls an operation of the heater 20. The controller 30 controls the power supply to the heater 20, such as to turn on and off the heater 20, so as to change a heating temperature of the sliding part by the heater 20.

The controller 30 controls the heater 20 to change the heating temperature at least one time at a start-up timing where the sliding of the sliding device 10A is started or during a normal operation time where the sliding of the sliding device 10A is being performed. In other words, the controller 30 controls the heater 20 to perform a temperature change operation to change the heating temperature of the sliding part.

In the present embodiment, for example, the controller 30 controls the heater 20 to change the heating temperature at the start-up timing of the sliding device 10A.

The start-up timing means a timing when the sliding is begun or a timing immediately after the sliding is begun. The normal operation time means the time where the sliding is constantly performed after a predetermined time period has elapsed since the start-up timing. Also, the change of the heating temperature, that is, the temperature change operation includes an increase in the temperature of the sliding part and a decrease in the temperature of the sliding part. For example, the change of the heating temperature corresponds to an operation to increase the temperature from a normal temperature to a first temperature (e.g., predetermined temperature) and then decrease the temperature from the first temperature to the normal temperature. Further, the controller 30 controls the heater 20 so that the heating temperature of the sliding part is ultimately kept in a predetermined temperature range after the change of the heating temperature.

In the sliding system 100, the base member 11 and the base member 12 are rotated relative to each other when the base member 12 is rotated by the external motor in the state where the base member 11 is held in the non-rotatable state by the gauge head. In the start-up timing of the sliding, the controller 30 turns on and off the heater 20 multiple times to produce the change of the heating temperature of the sliding part.

In an example shown in FIG. 12, the turning on and off of the heater 20 is repeated twice, and a third on state of the heater 20 is kept thereafter. When the heater 20 is in an on state, the temperature of the sliding part is increased to 80° C. When the heater 20 is in an off state, the temperature of the sliding part is decreased to approximately 40° C. After the repetition of turning on and off of the heater 20 and the keeping of the on state of the heater 20, the low friction state where the coefficient of friction μ is 0.01 is achieved in the sliding device 10A.

FIG. 13 is a graph illustrating a change in the coefficient of friction μ with the change in the heating temperature by the heater 20 during the normal operation time of the sliding device 10A. As shown in FIG. 13, when the heating temperature increases from approximately 60° C. to approximately 110° C., the coefficient of friction μ is equal to or less than 0.01. Therefore, it is appreciated that a temperature range for heating the sliding part and keeping the temperature of the sliding part is preferably in a range from 60° C. to 110° C. The temperature range from 60° C. to 110° C. corresponds to the predetermined temperature range.

As described above, the sliding device 10A of the present embodiment has the hard carbon film (carbon nitride film) 13 on the surfaces 11a, 12a of the base members 11, 12. The heating temperature of the sliding part is changed by the heater 20 and the controller 30 in the above described manner. Therefore, the low friction state where the coefficient of friction μ is equal to or less than 0.01 is stably maintained even in the atmosphere.

It is not always necessary to perform the temperature change operation at the start-up timing. The temperature change operation may be performed in the normal operation time or additionally performed in the normal operation time. The hard carbon film 13A formed on the surfaces 11a, 12a of the base members 11, 12 is not limited to the carbon nitride film. For example, the hard carbon film 13A may be provided by another film, such as an amorphous carbon film, a diamond film or the like.

In place of the hard carbon film 13A such as the carbon nitride film, the amorphous carbon film or the diamond film, the two-layer coating that includes the amorphous carbon film 13 and the amorphous silicon oxide film 14 of the first embodiment may be formed on at least one of the surfaces 11a, 12a of the base members 11, 12. The two-layer coating of the first embodiment solely achieves the coefficient of friction μ of 0.01. When the two-layer coating of the first embodiment is employed to the sliding system 100 of the present embodiment, the low friction state is further stably maintained because the temperature change operation is performed in the above described manner.

### Third Embodiment

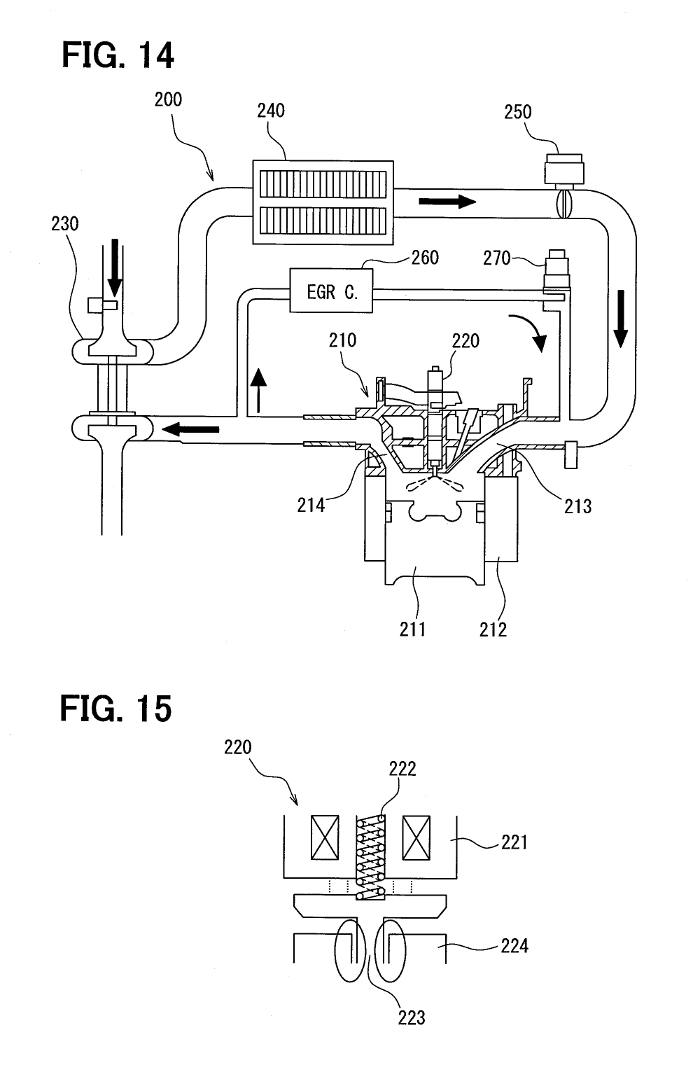

A sliding system of the third embodiment is shown in FIGS. 14 and 15. In the third embodiment, the sliding device 10, 10A is employed to a device of an engine system 200.

As shown in FIG. 14, the engine system 200 includes an engine 210, an injector 220, a turbocharger 230, an intercooler 240, an air intake throttle 250, an exhaust gas recirculation (EGR) cooler 260, an EGR valve 270 and the like.

The engine 210 is, for example, a diesel engine. In the engine 210, a piston 211 is reciprocated in a cylinder 212 by mixing intake air drawn from an intake port 213 with fuel injected from the injector 220, and compressing and combusting the mixture. The engine 210 generates a rotational driving force by the reciprocation of the piston 211 in the cylinder 212. Exhaust gas after the combustion is discharged from a discharge port 214.

The intake air is increased in pressure by the turbocharger 230 that is driven by energy of the exhaust gas from the exhaust port 214. Further, the intake air is cooled by the intercooler 240, and drawn into the intake port 213 after a flow rate thereof being controlled through the intake throttle 250.

A part of the exhaust gas is cooled at the EGR cooler 260 and drawn into the intake port 213 after a flow rate thereof being controlled through the EGR valve 270.

In the engine system 200 having the above described structure, the sliding devices 10, 10A of the above described first and second embodiments are, for example, employed to a sliding part between the piston 210 and the cylinder 212 of the engine 210.

To employ the sliding device 10, the two-layer coating including the hard carbon film 13 and the intermediate layer 14 is formed on at least one of the surface of the piston 211 and the surface of the cylinder 212. In such a case, a friction load between the piston 211 and the cylinder 212 is reduced even in the atmosphere. The piston 211 and the cylinder 212 are disposed adjacent to a combustion part of the engine 210 where heat is generated. That is, the piston 211 and the cylinder 212 are subject to a high temperature caused by the combustion. In this case, since the sliding part provided by the piston 211 and the cylinder 212 is heated by the heat of the combustion, the low friction state is favorably maintained.

To employ the sliding device 10A, the hard carbon film 13A is formed on at least one of the surface of the piston 211 and the surface of the cylinder 212. The hard carbon film 13 is, for example, the carbon nitride film, the amorphous carbon film or the diamond film. Also in such a case, since the sliding part is heated by the heat of the combustion, the favorable low friction state is realized.

As another example, the sliding devices 10, 10A are employed to the injector 220, as shown in FIG. 15. In the injector 220, a needle valve 223 slides inside of a holder 224 by means of a magnetic force (attraction force) generated by a solenoid 221 and a biasing force of a spring 222.

To employ the sliding device 10, the two-layer coating including the hard carbon film 13 and the intermediate layer 14 is formed on at least one of the surface of the needle valve 223 and the surface of the holder 224. In this case, the friction load between the needle valve 223 and the holder 224 can be reduced even in the atmosphere, similar to the above described sliding part provided between the piston 211 and the cylinder 212.

To employ the sliding device 10A, the hard carbon film 13A, which is provided by the carbon nitride film, the amorphous carbon film or the diamond film, is formed on at least one of the surface of the needle valve 223 and the surface of the holder 224. Also in such a case, the friction load between the needle valve 223 and the holder 224 can be reduced even in the atmosphere.

### Fourth Embodiment

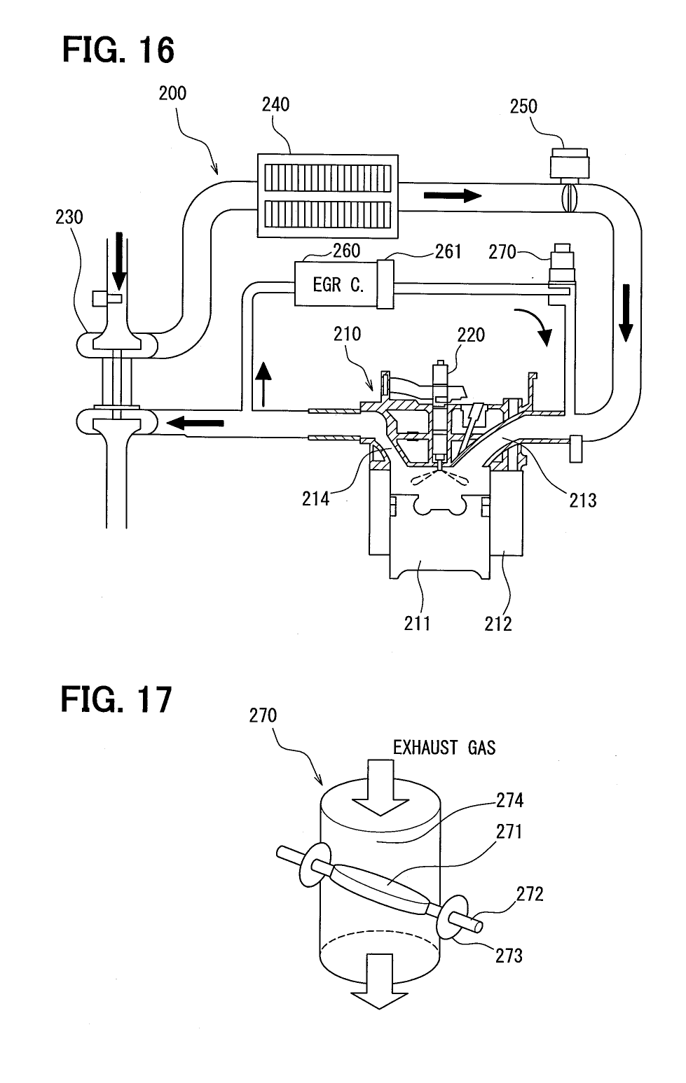

A fourth embodiment is shown in FIGS. 16 and 17. In the fourth embodiment, the low friction state is realized by controlling the heating temperature of the sliding part by a heat source in the engine system 200.

The sliding devices 10, 10A are employed to the EGR valve 270 shown in FIGS. 16 and 17. In the EGR valve 270, a rotation shaft 272 of a disc-shaped valve 271 is supported by bearings 273. The valve 271 is disposed inside of an exhaust gas passage 274 through which the exhaust gas (e.g., approximately 100° C.) flows. The rotation shaft 272 is rotated by a motor (not shown). The flow rate of exhaust gas in the exhaust gas passage 274 is controlled according to a rotational position of the valve 271.

The sliding devices 10, 10A are employed to a sliding part between the rotation shaft 272 and the bearing 273.

To employ the sliding device 10, the two-layer coating including the hard carbon film 13 and the intermediate layer 14 is formed on at least one of the surface of the rotation shaft 272 and the surface of the bearing 273. To employ the sliding device 10A, the hard carbon film 13A, which is provided by the carbon nitride film, the amorphous carbon film or the diamond film, is formed on at least one of the surface of the rotation shaft 272 and the surface of the bearing 273.

As shown in FIG. 16, the EGR cooler 260 is provided with a temperature control part 261 for controlling the temperature of the exhaust gas. For example, the temperature control part 261 controls the temperature of the exhaust gas by changing the flow rate of the exhaust gas flowing in the EGR cooler 260. As another example, the temperature control part 261 controls the temperature of the exhaust gas by changing the size of active cooling part of the EGR cooler 260, such as by controlling the number of tubes through which the exhaust gas flows at each time.

The temperature control part 261 controls the temperature of the exhaust gas so that the temperature of the exhaust gas downstream of the EGR cooler 260 is in the range from 60° C. to 100° C., for example.

In the present embodiment, the temperature of the exhaust gas is changed at least one time in the start-up timing of the EGR valve 270 or during the normal operation time, in the similar manner to the change of the heating temperature (temperature change operation) of the above described second embodiment.

Therefore, in the structure where the sliding device 10 is employed to the sliding part provided by the rotation shaft 272 and the bearing 273, the low friction state is realized even in the atmosphere by the low friction effect of the two-layer coating as well as the low friction state is stably maintained by the heating effect.

Also, in the structure where the sliding device 10A is employed to the sliding part provided by the rotation shaft 272 and the bearing 273, the low friction state is realized by the effect of the change of the heating temperature (temperature change operation) with respect to the hard carbon film 13A even in the atmosphere.

### Other Embodiments

In the engine systems 200 of the third and fourth embodiments, the heat of the exhaust gas is used as the heat source for heating the sliding devices 10, 10A. However, the heat source for heating the sliding devices 10, 10A is not limited to the heat of the exhaust gas. For example, the heat source for heating the sliding devices 10, 10A may be provided by exhaust heat dissipated when cooling an engine (e.g., exhaust heat from a radiator or a coolant), exhaust heat from an air conditioner (e.g., exhaust heat from a condenser), or the like.

While only the selected exemplary embodiments have been chosen to illustrate the present disclosure, it will be apparent to those skilled in the art from this disclosure that various changes and modifications can be made therein without departing from the scope of the disclosure as defined in the appended claims. The exemplary embodiments may be combined in various ways. Furthermore, the foregoing description of the exemplary embodiments according to the present disclosure is provided for illustration only, and not for the purpose of limiting the disclosure as defined by the appended claims and their equivalents.

What is claimed is:

1. A sliding device comprising:
a first base member having a first surface;
a second base member having a second surface, the second surface being opposed to the first surface, the first base member and the second base member sliding relative to each other;
a hard carbon film disposed on at least one of the first surface of the first base member and the second surface of the second base member; and
an intermediate layer disposed between the hard carbon film and the one of the first surface of the first base member and the second surface of the second base member, the intermediate layer being made of a compound containing silicon and oxygen.

2. The sliding device according to claim 1, wherein
the hard carbon film is an amorphous carbon film that satisfies a relation of I_{G}/I_{D}≧1 in a Raman spectrum, in which I_{G} is an intensity of a G-band caused by graphite and I_{D} is an intensity of a D-band caused by diamond.

3. The sliding device according to claim 1, wherein
the intermediate layer is an amorphous silicon oxide film that satisfies a relation of I_{SiO}/I_{SiO2}≧1 in an energy-loss near-edge structure spectrum of silicon, in which I_{SiO} is an intensity caused by silicon oxide and I_{SiO2} is an intensity caused by silicon dioxide.

4. A sliding system comprising:
the sliding device according to claim 1;
a heating device heating the sliding device; and
a control device controlling the heating device to perform a temperature change operation in which a heating temperature of the sliding device is increased to a predetermined temperature and decreased from the predetermined temperature and to keep the heating temperature in a predetermined temperature range after the temperature change operation.

5. The sliding system according to claim 4, wherein the control device controls the heating device to perform the temperature change operation at least one time at a start-up timing where a sliding operation of the sliding device is started.

6. The sliding system according to claim 4, wherein the control device controls the heating device to perform the temperature change operation at least one time during a normal operation time where the sliding device is in operation.

7. A sliding system comprising:
the sliding device according to claim 1, the sliding device being disposed adjacent to a heat source to be heated by the heat source; and
a temperature control part controlling the heat source to perform a temperature change operation in which a heating temperature of the sliding device is increased to a predetermined temperature and decreased from the predetermined temperature and to keep the heating temperature in a predetermined temperature range after the temperature change operation.

8. The sliding system according to claim 7, wherein the temperature change part controls the heat source to perform the temperature change operation at least one time in a start-up timing where a sliding operation of the sliding device is started.

9. The sliding system according to claim 7, wherein the temperature change part controls the heat source to perform the temperature change operation at least one time during a normal operation time where the sliding device is in operation.

10. A sliding system comprising:
a sliding device including a first base member, a second base member, and a hard carbon film, the first base member having a first surface, the second base member having a second surface opposed to the first surface, the first base member and the second base member sliding relative to each other, the hard carbon film being disposed on at least one of the first surface of the first base member and the second surface of the second base member;
a heating device heating the sliding device; and
a control device controlling the heating device to perform a temperature change operation in which a heating temperature of the sliding device is increased to a predetermined temperature and decreased from the predetermined temperature and to keep the heating temperature in a predetermined temperature range after the temperature change operation.

11. The sliding system according to claim 10, wherein the control device controls the heating device to perform the temperature change operation at least one time at a start-up timing where a sliding operation of the sliding device is started.

12. The sliding system according to claim 10, wherein the control device controls the heating device to perform the temperature change operation at least one time during a normal operation where the sliding device is in operation.

13. A sliding system comprising:
a sliding device being disposed adjacent to a heat source, the sliding device including a first base member, a second base member, and a hard carbon film, the first base member having a first surface, the second base member having a second surface opposed to the first surface, the first base member and the second base member sliding relative to each other, the hard carbon film being disposed on at least one of the first surface of the first base member and the second surface of the second base member; and
a temperature control part controlling the heat source to perform a temperature change operation in which a heating temperature of the sliding device is increased to a predetermined temperature and decreased from the predetermined temperature and to keep the heating temperature in a predetermined temperature range after the temperature change operation.

14. The sliding system according to claim 13, wherein the temperature change part controls the heat source to perform the temperature change operation at least one time at a start-up timing where a sliding operation of the sliding device is started.

15. The sliding system according to claim 13, wherein the temperature change part controls the heat source to perform the temperature change operation at least one time during a normal operation time where the sliding device is in operation.

16. The sliding system according to claim 13, wherein the hard carbon film is one of a carbon nitride film, an amorphous carbon film and a diamond film.

17. The sliding system according to claim 10, wherein the hard carbon film is one of a carbon nitride film, an amorphous carbon film and a diamond film.
